(19) United States
(12) Patent Application Publication
(10) Pub. No.: US 2017/0180451 A1
(43) Pub. Date: Jun. 22, 2017

(54) SYSTEM AND METHOD FOR REMOTELY ACCESSING A LOCAL COMPUTER NETWORK VIA A WEB INTERFACE

(71) Applicant: GETIT REMOTE L.L.C., Louisville, KY (US)

(72) Inventors: Lee E. Shaffer, Lexington, IN (US); Adam K. Jones, Scottsburg, IN (US)

(73) Assignee: GETIT REMOTE L.L.C., Louisville, KY (US)

(21) Appl. No.: 15/115,950

(22) PCT Filed: Feb. 11, 2015
(86) PCT No.: PCT/US15/15313

§ 371 Date: Aug. 2, 2016

Related U.S. Application Data
(60) Provisional application No. 61/938,202, filed on Feb. 11, 2014.

(51) Int. Cl. H04L 29/08

(52) U.S. Cl. CPC H04L 67/025; H04L 67/141; H04L 67/146

(57) ABSTRACT

Embodiments of this invention relate to remote access of a local computer network. More specifically, embodiments of this invention relate to a computer system and computer-implemented method for receiving instructions from a remote user to establish remote access to a local computer network, and responding by receiving one or more unique identifiers configured to identify the local computer network and establishing secure remote access to the local computer network. Instructions are received from the remote user via a web interface.

This application claims the benefit of priority to U.S. Provisional Patent Application Ser. No. 61/938,202, filed Feb. 11, 2014, entitled System and Method for Accessing Local and Networked Directories and File in a Web Interface, the disclosure of which is expressly incorporated herein by reference.

### FIELD

Embodiments of this invention relate to remote access of a local computer network. More specifically, embodiments of this invention relate to a computer system and computer-implemented method for receiving instructions from a remote user to establish remote access to a local computer network, and responding by receiving one or more unique identifiers configured to identify the local computer network and establishing secure remote access to the local computer network. Instructions are received from the remote user via a web interface.

### BACKGROUND

Users have for some time now desired the ability to access and modify their local and/or networked files online. Various platforms have risen to meet this need, such as systems allowing users to upload their files into a network-based distributed computing system, commonly referred to as the “cloud,” and access the files via a web interface from any location. Other systems provide remote access to files by periodically synchronizing local and/or networked files with corresponding copies of the files on a remote system through the cloud. What lacks in the market is the ability to access the user's actual server or computer and/or network from the web and also access it securely and access and modify the files and directories you need. Users want the ability to access and modify their files without having to upload them to another structure or location, or sync them from their server to another location in the cloud.

Therefore a need exists for a system designed to allow users to securely access files from their own local computer and/or network from a remote location without having to host those files and directories on a cloud system or sync remote copies of the files and directories with local copies.

### SUMMARY

Various embodiments of the present invention pertain to systems and methods for remotely and securely accessing files on a local computer network via a web interface

One aspect of the present invention pertains to a computer-implemented method comprising providing, by a computing system, a web interface for use by a remote user of a local computer network, receiving, by the computing system, a request made by the remote user via the web interface to establish remote access from the computing system to the local computer network, responding, by the computing system, to the received request by obtaining one or more unique identifiers configured to identify the local computer network and by establishing a secure access connection from the computing system to the local computer network, receiving, by the computer system, an instruction made by the remote user via the web interface to access one or more files or directories on the local computer network, and responding, by the computer system, to the received instruction by transmitting the instruction to the local computer network for execution by the local computer network, wherein establishing a secure access connection to the local computer network provides access to one or more files or directories on the local computer network pre-selected as approved for remote access and pre-selected as permitted for access by the remote user.

In some embodiments, the user accesses the web interface via a web browser on a remote device. In further embodiments, the remote device is a general purpose computer, a tablet computer, or a smart phone. In certain embodiments, the one or more unique identifiers are obtained by the computing system from an enterprise service bus receiving the one or more unique identifiers stored by the local computer network. In some embodiments, the secure access connection is established by the computing system matching the remote user to the one or more unique identifiers. In further embodiments, the remote user is matched to the one or more unique identifiers by querying a database of user records. In certain embodiments, the one or more unique identifiers are stored by a local client system service hosted on the local computer network. In some embodiments, the one or more unique identifiers are globally unique identifiers. In further embodiments, execution of the received instruction by the local computer network modifies the one or more files or directories on the local computer network. In certain embodiments, execution of the received instruction by the local computer network creates a link providing remote access to the one or more files or directories on the local computer network. In some embodiments, execution of the instruction by the local computer network is enacted by a local client system service hosted on the local computer network.

Another aspect of the present invention pertain to a computing system comprising a database of user records, one or more processors, one or more memories including programming that, when executed by at least one of the one or more processors, causes the computing system to receive a request made by a user via a remote device to establish remote access from the computing system to a local computer network, wherein the database includes a user record for the user, respond to the received request by obtaining one or more unique identifiers configured to identify the local computer network and by establishing a secure access connection from the computing system to the local computer network, receive an instruction made by the user via the remote device to access or modify one or more files or directories on the local computer network, and respond by transmitting the instruction to the local computer network for execution by the local computer network, wherein establishing a secure access connection from the computing system to the local computer network provides access to one or more of files and directories on the local computer network pre-selected as approved for remote access and pre-selected as permitted for access by said user.

In some embodiments, the one or more unique identifiers are globally unique identifiers specific for the local computer network. In further embodiments, the user record associates the user with the one or more unique identifiers. In certain embodiments, the one or more memories include programming that, when executed by at least one of the one or more processors, cause the computing system to provide a web interface accessible by a web browser on the remote device. In some embodiments, the request and the instruction are submitted by the user to the web interface. In further embodiments, the instruction is executed by a local client system service hosted on the local computer network. In certain embodiments, the modifications to the one or more files and directories on the local computer network are saved on the local computer network. In some embodiments, the local computer network is a single computer. In further embodiments, the one or more unique identifiers are obtained by the computing system from an enterprise service bus receiving the one or more unique identifiers stored by a local client system service hosted on the local computer network.

A further aspect of the present invention pertains to a non-transitory computer-readable medium comprising stored contents that configure a computing system to receive a request made by a user via a remote device to establish remote access from the computing system to a local computer network, respond to the received request by obtaining one or more unique identifiers configured to identify the local computer network and by establishing a secure access connection from the computing system to the local computer network, receive an instruction made by the user via the remote device to access or modify one or more files or directories on the local computer network, and respond by transmitting the instruction to the local computer network for execution by the local computer network, wherein establishing a secure access connection from the computing system to the local computer network provides access to one or more of files and directories on the local computer network pre-selected as approved for remote access and pre-selected as permitted for access by said user.

In some embodiments, the stored contents further configure the computing system to provide a web interface accessible by a web browser on the remote device. In further embodiments, the request and the instruction are submitted by the user to the web interface. In certain embodiments, execution of the received instruction by the local computer network modifies the one or more files or directories on the local computer network. In some embodiments, execution of the received instruction by the local computer network creates an activatable link providing remote access to the one or more files or directories on the local computer network. In further embodiments, activating the activatable link provides anonymous remote access to the one or more files or directories on the local computer network. In certain embodiments, the one or more unique identifiers are obtained by the computing system from an enterprise service bus receiving the one or more unique identifiers stored by a local client system service hosted on the local computer network. In some embodiments, the secure access connection is established by the computing system matching the user to the one or more unique identifiers.

### BRIEF DESCRIPTION OF THE DRAWINGS

A better understanding of the present invention will be had upon reference to the following description in conjunction with the accompanying drawings.

FIG. 1 is a schematic illustrating an embodiment of a computing system.

FIG. 2 is a flowchart illustrating access of a local computer network via an embodiment of a computing system according to the present invention.

### DETAILED DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention.

Any reference to “the invention” is a reference to an embodiment of a family of inventions, with no single embodiment including an apparatus, method, process, or composition that should be included in all embodiments, unless otherwise stated. Further, although there may be discussion with regards to “advantages” provided by some embodiments of the present invention, it is understood that yet other embodiments may not include those same advantages, or may include yet different advantages. Any advantages described herein are not to be construed as limiting to any of the claims.

Disclosed herein is a computing system and computer-implemented method for allowing users to access files on their local computer network via a web browser from a remote device. In some embodiments, the users and the local computer network are members of a single domain group in a directory service. In some embodiments, the remote device is the computing device being utilized by the user to remotely access the computing system, and may include a general purpose computer, tablet computer, smart phone, or other computing device. The user has the capability to access files on the local server or local network and to open, download copies, and share the files to other users, create new directories, delete files and directories, upload files and rename files and directories. From a user's perspective, the system provides the functionality of a file manager application, but for remotely accessing files from the user's local server or network. As used herein, the term “local computer network” refers to a computer network that the user may have the capability to access locally, and presently desires to access remotely. The local computer network need not be local to the user's current location. In some embodiments, the local computer network is a single network-connected computer. In other embodiments, the local computer network is a plurality of network-connected computers.

A computing system utilized in conjunction with embodiments described herein will typically include one or more processors in communication with one or more memories, and a network interface. Power, ground, clock, and other signals and circuitry are not discussed, but will be generally understood and easily implemented by those skilled in the art. The processors, in some embodiments, are at least one microcontroller or general purpose microprocessor that reads its program from memory. The memories, in some embodiments, include one or more types such as solid-state memory, magnetic memory, optical memory, or other computer-readable, non-transient storage media. In certain embodiments, the one or more memories include instructions that, when executed by at least one of the one or more processors, cause the computing system to perform an action. The network interface connects the computing system to a data network for electronic communication of data between the computing system and other devices attached to the network. In some embodiments, the computing system is one or more physical computing devices as described above. In other embodiments, the computing system is a virtual system hosted on one or more physical computing devices as described above.

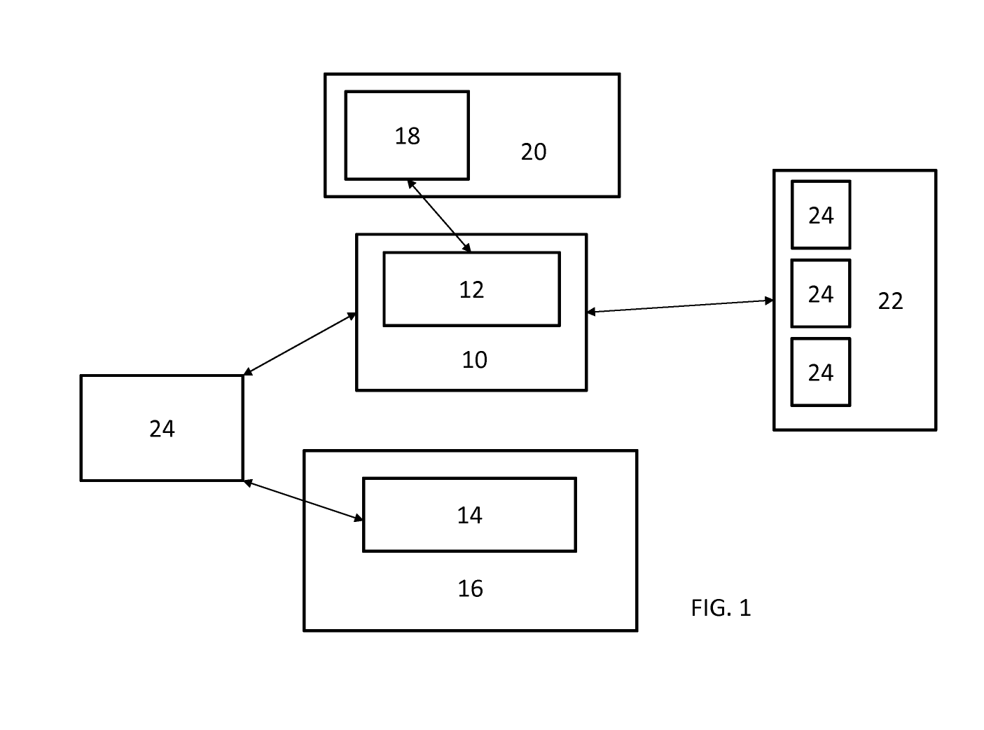

Referring to FIG. 1, the computing system 10 includes a web interface 12 that follows the traditional server-client architecture. The computing system 10 utilizes http security through Secure Sockets Layer (“SSL”), Transport Layer Security (“TLS”) or similar means. The computing system 10 generates a unique identifier or “token” and sends it to a local client system service 14 via a network-based distributed computing system. The local client system service 14 is software installed on the local computer network 16, the functionality of which is explained in further detail below. In certain embodiments, the local client system service 14 is the Getlt Remote File Explorer offered by Getlt Remote L.L.C.

A user accesses the web interface 12 provided by the computing system via a web browser 18 on a remote device 20. In some embodiments, the remote device 20 is a general purpose computer, tablet computer, smart phone, or other network-connection computing device. The user attempts to log into the computing system 10 by providing a username and password. In response, the computing system 10 accesses a user record database 22 in electronic communication with the computing system 10, and compares the username and password to a user record 24 in the user record database 22 specific to that user. If a valid username and password are found, the user is authenticated. In some embodiments, if the user is not authenticated, an error message is shown to the user indicating that login was unsuccessful.

Once authenticated, the user provides, and the computing system 10 receives, a request to establish remote access to the user's local computer network 16. The computing system 10 responds by retrieving one or more unique identifiers from the user record 24 specific to the user. In some embodiments, the one or more unique identifiers are two Globally Unique Identifiers (“GUIDs”). The GUIDs are used to identify which endpoint the computing system 10 will connect to for the user, namely the user's local computer network 16. A local client system service 14 runs on the user's local computer network 16 and stores two unique GUIDs. One GUID is for standard data, such as directories and file names and sizes. The other GUID is used to stream files to the computing system 10 and to the user's browser for download.

Once the unique identifiers are retrieved from the user record database 22, the computing system 10 utilizes an enterprise service bus 26 to make a secure TCP connection to the user's endpoint, namely, the local computer network 16. The enterprise system bus 26 detects the two GUIDs stored by the local client system service 14. The computing system 10 matches the GUIDs stored in the user record 24 to the GUIDs detected by the enterprise system bus 24 to securely connect the user to the user's endpoint.

The user or an administrator of the local computer network 16 designates one or more of files and directories on the local computer network as approved for remote access. In some embodiments, in order to share files and directories to the computing system 10, the user selects a file or directory on their local computer network 16 where the local client system service 14 is installed. A menu option is presented to the user, such as, for example, a menu option that states “Share with GetIt Remote.” The user can select that option to approve that file or directory to become accessible to the local client system service 14. When that option is selected, an exposure record is created on the local computer network 16 that lists which files and directories are accessible in the cloud. In some embodiments the exposure record is an xml file. In some embodiments, the exposure record listing files and directories approved for remote access is created prior to the user requesting remote access to the local computer network 16.

The computing system 10 checks the client exposure record to retrieve a list of directories that are shared. After retrieving a list of approved directories the computing system 10 returns that data to the web browser 18. In some embodiments, the browser 18 exposes that information to the user as the user's accessibility screen.

Upon successful authentication of the user's login, the user is presented a file management screen. On initial load of the file management screen, an action is performed to determine the user's proper file system permissions to each directory and file. Instructions are passed from the computing system 10 via the enterprise service bus 26 to the local client system service 14. Access to local files and folders is verified by a query to the directory controller on the local computer network 16, which will return file system permission for the user currently logged in. In some embodiments, the query is a Lightweight Directory Access Protocol (“LDAP”) query, the directory controller is an Active Directory controller, and the file system is New Technology File System (“NTFS”).

The action recursively checks each directory and file that is initially shown in the file management screen and the logged on user's permission to those directories and files by utilizing the file layer to access a file system rule object and check the user's active permissions to each file and directory. If the user does not have read permission to a directory then that directory will not be shown in the tree view of the file management screen. Once all directories are shown the page load is completed.

In some embodiments, each instruction made by the user to access or modify directories and files by clicking on those items in the web browser is routed through the web interface 12 to the computing system 10, through the enterprise service bus 26 using the GUIDs, and onward to the local client computer system service 14 hosted on the local computer network 16. The local client computer system service 14 executes the instruction and returns data to the enterprise service bus 26, which in turn routes the data back to the computing system 10, which then displays the data to the user via the web interface 12.

When the user provides an instruction to access a directory, such as by selecting a directory displayed in the web browser 18, the file layer is accessed and every file in the directory is searched by accessing a file 10 object to recursively select every file in the directory and any sub-directories. For each file and sub-directory, the user's local file system permissions are checked by utilizing the file layer to access a file system rule object and check the user's active permissions to each file and directory. In some embodiments, directories the user does not have permission to access are not displayed to the user. In other embodiments, directories the user does not have permission to access are displayed, but are not accessible to the user. In some embodiments, files the user does not have permission to access are displayed to the user, but are not accessible. In other embodiments, files that the user does not have permission to access are not displayed to the user.

When the user provides an instruction to access a file, such as by selecting a file displayed in the web browser 18, the file layer is accessed and the user's local file system permissions are checked by utilizing the file layer to access a file system rule object and check the user's active permission to the file name passed to it. If the system determines the user does not have local file system read permissions, an error is returned and the user is notified they do not have access to the resource. If the system determines the user has local file system read permissions to the file then the system executes an http transmit to stream the file contents to the user's remote device.

In some embodiments, the computing system 10 allows a user to share access to files and directories that are approved for remote access and that the user is permitted to access. The user provides an instruction to share access to a file. The instruction is received by the computing system 10, then transmitted via the enterprise service bus 26 to the local client system service 14 for execution. The computing system 10 verifies the user has local file system read permissions by accessing the file system access rule object. If the user does not have local file system read permission, the system presents the user with a message indicating that access is denied. The user then optionally establishes a password associated with the file to share to restrict access to the file. In some embodiments, the computing system 10 then utilizes an URL shortening application programming interface (API), such as, for example, Goo.gl offered by Google Inc., bitty® offered by Bitly, Inc. or TinyURL.com® offered by Gilby Productions, to create a secure link that contains query string parameters that contain encrypted information that allows the computing system 10 to share the resource to anonymous users. The computing system 10 creates an anonymous link to the share resource by accessing a link creation method and presents the link to the user.

An anonymous user can enter the link into a web browser to access the file shared by the user. The computing system 10 checks if the shared resource is password protected by accessing the query string parameter. This check is performed by the computing system 10 passing an instruction via the enterprise service bus 26 to the local client system service 14 for execution on the local computer network 16. If the shared resource is password protected, the user is solicited to enter a password. The computing system 10 determines if the entered password is correct by matching the entered password with the query string parameter. If the entered password is incorrect, the computing system 10 sends back an incorrect password text. If the entered password is correct, the computing system 10 accesses the shared resource by extracting the originating user's credentials from query string parameters. The computing system 10 streams the file to the anonymous user by utilizing the http transmit object and impersonating the originating user by utilizing the originating user's credentials.

The system can upload files from the remote device 20 to the local computer network 16 through the file upload control. Once a file is entered for upload, the computing system 10 streams the selected file from the remote device 20 to the computing system 10, then through the enterprise service bus 26 to the local computer network 16 in the file upload control file system access object. Local file system permissions of the user are applied to the uploaded file in the directory the file is uploaded to by accessing the file system access rule object and applying the same local file system permissions of the user in the directory to the uploaded file.

The computing system 10 can delete files on the local computer network 16 chosen by the remote user. The user provides an instruction to delete a file to the web interface 12 via the remote device 20. The computing system 10 transmits the instruction via the enterprise service bus 26 to the local client service system 14 for execution. Upon execution, the local file system permission of the user on the file selected through the file system access rule object is checked. If the user has local file system write and modify permissions the local client system service 14 will access the file layer 10 object and delete the file which will remove the file from the originating network location. If the user does not have local file system write and modify permissions determined by the file system access rule object then the user is presented with an access denied message.

In some embodiments, the computing system 10 utilizes a license mechanism using a license manager object. At least one of the one or more unique identifiers associated with the user in the user record 24 includes a time stamp. In certain embodiments, the time stamp is set when the user installs the local client system service 14 on the local computer network 16, when the user first remotely accesses the computing system 10, or when another pre-determined event occurs. In certain embodiments, the one or more unique identifiers are assigned to the user record 24 and the time stamp is set when the user installs the local client system service 14 on the local computer network 16. Each time the user submits a request to establish remote access, the computing system 10 accesses the license manager object and verifies that the license is active. In some embodiments, the computing system performs this verification by executing a SQL query that extracts the unique identifier for the user, checks the time stamp, and compares it to a payment record for the user to confirm that the user's payments are current from the date of the time stamp to the date of the current request to establish remote access.

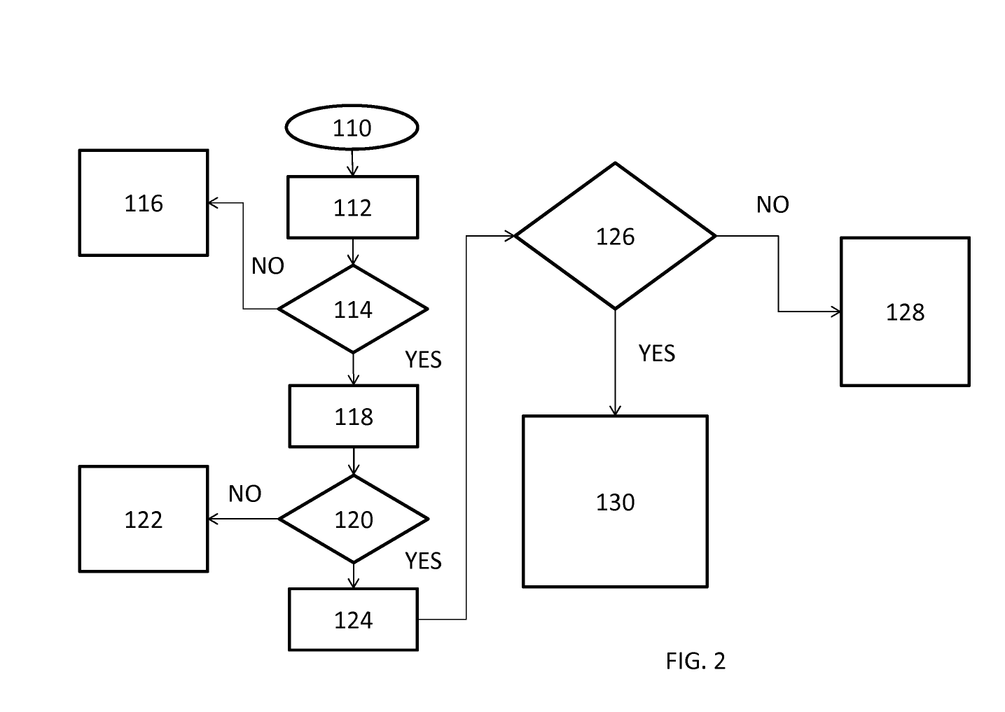

FIG. 2 describes an example of a user accessing and utilizing an embodiments of the present invention, including:

110—the user accessing the web interface 12 via the web browser 18 on the remote device 20;

112—the user entering a username and password;

114—the computing system 10 comparing the username and password to user records 24 in the user record database 22 specific to that user;

116—in the event that the username and password do not match a user record 24, returning an error message to the user;

118—in the event that the username and password do match a user record 24, the computing system 10 retrieving one or more unique identifiers from the user record 24 specific to the user;

120—the computing system 10 utilizing an enterprise service bus 26 to detect the GUIDs stored by the local client system service 14, which are identical to the unique identifiers stored in the user record 24 specific to the user;

122—in the event that the GUIDs are not detected, returning an error message to the user;

124—in the event that the GUIDs are detected, establishing a secure TCP connection to the local computer network 16;

126—the computing system 10 comparing a user's instruction to access or modify a file or directory to the user's file system permission for that file or directory;

128—in the event that the user does not have permission to access or modify that file or directory, returning an error message to the user;

130—in the event that the user has permission to access or modify that file or directory, executing the user's instruction.

Various aspects of different embodiments of the present invention are expressed in paragraphs X1, X2 and X3, as follows:

X1. One aspect of the present invention pertains to a computer-implemented method comprising providing, by a computing system, a web interface for use by a remote user of a local computer network, receiving, by the computing system, a request made by the remote user via the web interface to establish remote access from the computing system to the local computer network, responding, by the computing system, to the received request by obtaining one or more unique identifiers configured to identify the local computer network and by establishing a secure access connection from the computing system to the local computer network, receiving, by the computer system, an instruction made by the remote user via the web interface to access one or more files or directories on the local computer network, and responding, by the computer system, to the received instruction by transmitting the instruction to the local computer network for execution by the local computer network, wherein establishing a secure access connection to the local computer network provides access to one or more files or directories on the local computer network pre-selected as approved for remote access and pre-selected as permitted for access by the remote user.

X2. Another aspect of the present invention pertain to a computing system comprising a database of user records, one or more processors, one or more memories including programming that, when executed by at least one of the one or more processors, causes the computing system to receive a request made by a user via a remote device to establish remote access from the computing system to a local computer network, wherein the database includes a user record for the user, respond to the received request by obtaining one or more unique identifiers configured to identify the local computer network and by establishing a secure access connection from the computing system to the local computer network, receive an instruction made by the user via the remote device to access or modify one or more files or directories on the local computer network, and respond by transmitting the instruction to the local computer network for execution by the local computer network, wherein establishing a secure access connection from the computing system to the local computer network provides access to one or more of files and directories on the local computer network pre-selected as approved for remote access and pre-selected as permitted for access by said user.

X3. A further aspect of the present invention pertains to a non-transitory computer-readable medium comprising stored contents that configure a computing system to receive a request made by a user via a remote device to establish remote access from the computing system to a local computer network, respond to the received request by obtaining one or more unique identifiers configured to identify the local computer network and by establishing a secure access connection from the computing system to the local computer network, receive an instruction made by the user via the remote device to access or modify one or more files or directories on the local computer network, and respond by transmitting the instruction to the local computer network for execution by the local computer network, wherein establishing a secure access connection from the computing system to the local computer network provides access to one or more of files and directories on the local computer network pre-selected as approved for remote access and pre-selected as permitted for access by said user.

Yet other embodiments pertain to any of the previous statements X1, X2 or X3 which are combined with one or more of the following other aspects.

Wherein the user accesses the web interface via a web browser on a remote device.

Wherein the remote device is a general purpose computer, a tablet computer, or a smart phone.

Wherein the one or more unique identifiers are obtained by the computing system from an enterprise service bus receiving the one or more unique identifiers stored by the local computer network.

Wherein the secure access connection is established by the computing system matching the remote user to the one or more unique identifiers.

Wherein the remote user is matched to the one or more unique identifiers by querying a database of user records.

Wherein the one or more unique identifiers are stored by a local client system service hosted on the local computer network.

Wherein the one or more unique identifiers are globally unique identifiers.

Wherein execution of the received instruction by the local computer network modifies the one or more files or directories on the local computer network.

Wherein execution of the received instruction by the local computer network creates a link providing remote access to the one or more files or directories on the local computer network.

Wherein execution of the instruction by the local computer network is enacted by a local client system service hosted on the local computer network.

Wherein the one or more unique identifiers are globally unique identifiers specific for the local computer network.

Wherein the user record associates the user with the one or more unique identifiers.

Wherein the one or more memories include programming that, when executed by at least one of the one or more processors, cause the computing system to provide a web interface accessible by a web browser on the remote device.

Wherein the request and the instruction are submitted by the user to the web interface.

Wherein the instruction is executed by a local client system service hosted on the local computer network.

Wherein modifications to the one or more files and directories on the local computer network are saved on the local computer network.

Wherein the local computer network is a single computer.

Wherein the one or more unique identifiers are obtained by the computing system from an enterprise service bus receiving the one or more unique identifiers stored by a local client system service hosted on the local computer network.

Wherein the stored contents further configure the computing system to provide a web interface accessible by a web browser on the remote device.

Wherein the request and the instruction are submitted by the user to the web interface.

Wherein execution of the received instruction by the local computer network creates an activatable link providing remote access to the one or more files or directories on the local computer network.

Wherein activating the activatable link provides anonymous remote access to the one or more files or directories on the local computer network.

Wherein the one or more unique identifiers are obtained by the computing system from an enterprise service bus receiving the one or more unique identifiers stored by a local client system service hosted on the local computer network.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1) A computer-implemented method comprising:
providing, by a computing system, a web interface for use by a remote user of a local computer network;
receiving, by the computing system, a request made by the remote user via the web interface to establish remote access from the computing system to the local computer network;
responding, by the computing system, to the received request by obtaining one or more unique identifiers configured to identify the local computer network and by establishing a secure access connection from the computing system to the local computer network;
receiving, by the computer system, an instruction made by the remote user via the web interface to access one or more files or directories on the local computer network; and
responding, by the computer system, to the received instruction by transmitting the instruction to the local computer network for execution by the local computer network;
wherein establishing a secure access connection to the local computer network provides access to one or more files or directories on the local computer network pre-selected as approved for remote access and pre-selected as permitted for access by the remote user.

2) The computer-implemented method of claim 1, wherein the user accesses the web interface via a web browser on a remote device.

3) The computer-implemented method of claim 2, wherein the remote device is a general purpose computer, a tablet computer, or a smart phone.

4) The computer-implemented method of claim 1, wherein the one or more unique identifiers are obtained by the computing system from an enterprise service bus receiving the one or more unique identifiers stored by the local computer network.

5) The computer-implemented method of claim 4, wherein the secure access connection is established by the computing system matching the remote user to the one or more unique identifiers.

6) The computer-implemented method of claim 5, wherein the remote user is matched to the one or more unique identifiers by querying a database of user records.

7) The computer-implemented method of claim 4, wherein the one or more unique identifiers are stored by a local client system service hosted on the local computer network.

8) The computer-implemented method of claim 1, wherein the one or more unique identifiers are globally unique identifiers.

9) The computer-implemented method of claim 1, wherein execution of the received instruction by the local computer network modifies the one or more files or directories on the local computer network.

10) The computer-implemented method of claim 1, wherein execution of the received instruction by the local computer network creates a link providing remote access to the one or more files or directories on the local computer network.

11) The computer-implemented method of claim 1, wherein execution of the instruction by the local computer network is enacted by a local client system service hosted on the local computer network.

12) A computing system comprising:
a database of user records;
one or more processors;
one or more memories including programming that, when executed by at least one of the one or more processors, causes the computing system to:
receive a request made by a user via a remote device to establish remote access from the computing system to a local computer network, wherein the database includes a user record for the user;
respond to the received request by obtaining one or more unique identifiers configured to identify the local computer network and by establishing a secure access connection from the computing system to the local computer network;
receive an instruction made by the user via the remote device to access or modify one or more files or directories on the local computer network; and
respond by transmitting the instruction to the local computer network for execution by the local computer network;
wherein establishing a secure access connection from the computing system to the local computer network provides access to one or more of files and directories on the local computer network pre-selected as approved for remote access and pre-selected as permitted for access by said user.

13) The system of claim 12, wherein the one or more unique identifiers are globally unique identifiers specific for the local computer network.

14) The system of claim 12, wherein the user record associates the user with the one or more unique identifiers.

15) The system of claim 12, wherein the one or more memories include programming that, when executed by at least one of the one or more processors, cause the computing system to provide a web interface accessible by a web browser on the remote device.

16) The system of claim 15, wherein the request and the instruction are submitted by the user to the web interface.

17) The system of claim 12, wherein the instruction is executed by a local client system service hosted on the local computer network.

18) The system of claim 12, wherein modifications to the one or more files and directories on the local computer network are saved on the local computer network.

19) The system of claim 12, wherein the local computer network is a single computer.

20) The system of claim 12, wherein the one or more unique identifiers are obtained by the computing system from an enterprise service bus receiving the one or more unique identifiers stored by a local client system service hosted on the local computer network.

21) A non-transitory computer-readable medium comprising stored contents that configure a computing system to:
receive a request made by a user via a remote device to establish remote access from the computing system to a local computer network;
respond to the received request by obtaining one or more unique identifiers configured to identify the local computer network and by establishing a secure access connection from the computing system to the local computer network;
receive an instruction made by the user via the remote device to access or modify one or more files or directories on the local computer network; and
respond by transmitting the instruction to the local computer network for execution by the local computer network;
wherein establishing a secure access connection from the computing system to the local computer network provides access to one or more of files and directories on the local computer network pre-selected as approved for remote access and pre-selected as permitted for access by said user.

22) The medium of claim 21, wherein the stored contents further configure the computing system to provide a web interface accessible by a web browser on the remote device.

23) The medium of claim 21, wherein the request and the instruction are submitted by the user to the web interface.

24) The medium of claim 21, wherein execution of the received instruction by the local computer network modifies the one or more files or directories on the local computer network.

25) The medium of claim 21, wherein execution of the received instruction by the local computer network creates an activatable link providing remote access to the one or more files or directories on the local computer network.

26) The medium of claim 25, wherein activating the activatable link provides anonymous remote access to the one or more files or directories on the local computer network.

27) The medium of claim 21, wherein the one or more unique identifiers are obtained by the computing system from an enterprise service bus receiving the one or more unique identifiers stored by a local client system service hosted on the local computer network.

28) The medium of claim 21, wherein the secure access connection is established by the computing system matching the user to the one or more unique identifiers.
